(19) United States
(12) Patent Application Publication
(10) Pub. No.: US 2010/0166411 A1
(43) Pub. Date: Jul. 1, 2010

(54) MAST ASSEMBLY

(76) Inventors: Matthew Gladstone, Buckinghamshire (GB); Andrew Redman, Wiltshire (GB)

Correspondence Address: LAW OFFICE OF JAMES TROSINO, P.O. BOX 200, YONKERS, NY, 10703, US

(21) Appl. No.: 12/278,143

(22) PCT Filed: Feb. 2, 2007
(86) PCT No.: PCT/GB07/00366

§ 371 Date: Mar. 31, 2009

(30) Foreign Application Priority Data
Feb. 3, 2006 (GB) 0602222.2

(51) Int. Cl. G03B 17/00; F16M 11/04

(52) U.S. Cl. 396/419; 248/122.1

(57) ABSTRACT

A camera mast assembly comprising two or more sections movable with respect to one another from an unextended to an extended configuration, and a carriage attached to one of the sections for mounting a camera on the assembly, wherein the carriage is continuously movable in a substantially uniform manner from a first position wherein the sections are in the unextended configuration to a second position wherein the sections are in the extended configuration.

The invention relates to adjustable masts and to a camera mast assembly for enabling movement of a camera primarily from a lowered to a raised position in a substantially smooth and continuous manner.

It is known that high angle shots in film and television can be achieved in a number of ways. Manned cameras can be used for filming from hoists, helicopters, and balloons. Such systems are usually expensive to achieve; they may be inoperable in strong winds or poor weather conditions and can not usually react quickly to changes required in the shot. Furthermore, helicopters are limited by air space and radio links. Moreover, hoists and balloons are not used for dynamic shots.

Remotely controlled cameras can be used on devices such as remotely controlled planes or helicopters, but again these systems can be limited by poor weather conditions and the shots taken can be unstable or shaky. Use of gyroscopic camera mounts may improve the situation but can be an expensive solution. Alternative remote systems used for low to high angle camera shots include camera cranes and wire-mounted camera systems but their location can be restricted by the size, arrangement and weight of the equipment concerned and they can take many hours to set up.

Furthermore, one of the common problems suffered in this form of filming is the inability of the system used to achieve completely straight vertical motion during filming.

Telescopic masts have been used to achieve high angle shots in film and television shooting. Indeed, such masts have been designed specifically for use with television and film cameras. These known masts can extend up to 10 m and may be mounted on a stand or a dolly. These masts can be used for vertically dynamic shots but the lowest camera height they can reach is restricted to the length of the first section. An example of an existing system is sold under the Trade Mark TOWERCAM XL by Specialized Remote Camera Systems.

However, some such telescopic masts do not provide substantially smooth continuous motion in raising and lowering the camera. This is because each of the sections are progressively withdrawn or extended thereby effecting abutment between adjacent sections before subsequent sections are extended. This encourages a slightly jerky motion to the camera when the mast is extended and retracted. Moreover, the camera cannot be lowered any further than the height of the sections in their lowermost telescopic form (ie limited at least by the length of the main section).

Other types of telescopic mast are known but these are normally used in telecommunications. Such masts were successful and were able to reach heights of about 30 m and are known to have been used with film and television cameras. However, at these heights such masts had to be stabilised by attaching guy ropes from the top of the mast to the ground. Accordingly, camera shots taken using such camera systems can only be static shots.

The present invention seeks to avoid or at least mitigate these and other problems in the prior art. In particular, the invention seeks to provide a camera mast assembly enabling substantially continuous and smooth movement of a camera in use to enable continuous filming in raising and lowering the camera especially from a substantially ground level position to an uppermost position in the order of 30 metres. Moreover, the invention seeks to provide an easily erectable camera mast assembly being stable in use and/or flexible, lightweight, transportable and robust.

According to a first aspect of the invention there is provided a camera mast assembly comprising two or more sections moveable with respect to one another from an unextended to an extended configuration, and a carriage attached to one of the sections for mounting a camera on the assembly, wherein the carriage is continuously moveable in a substantially uniform manner from a first position wherein the sections are in the unextended configuration to a second position wherein the sections are in the extended configuration.

Other aspects and preferred features of the invention and will be apparent from the following description and are set out in the attached claims.

An embodiment of the invention will now be described, by way of example only, with reference to the accompanying drawings, in which:

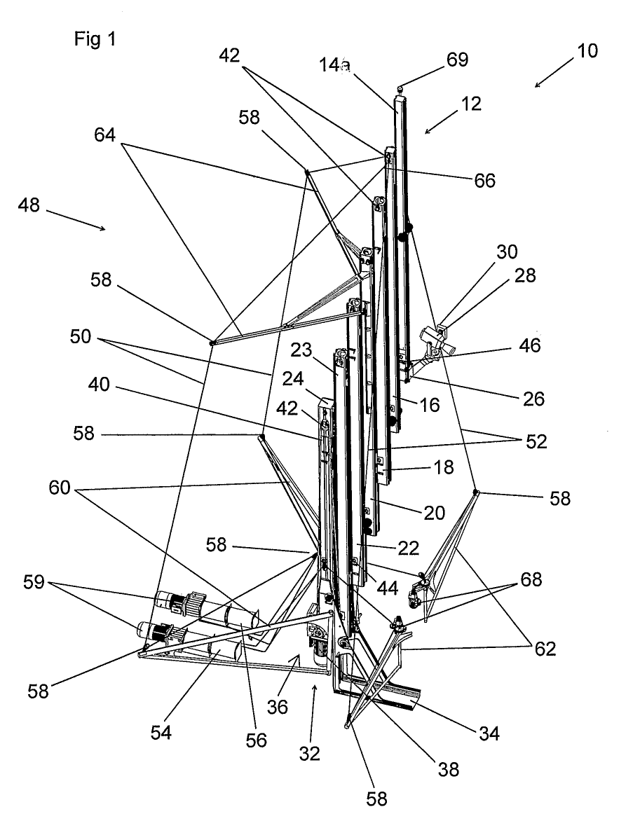

FIG. 1 is a schematic perspective view of a camera mast assembly according to the invention when the camera is in a deployed and lower position;

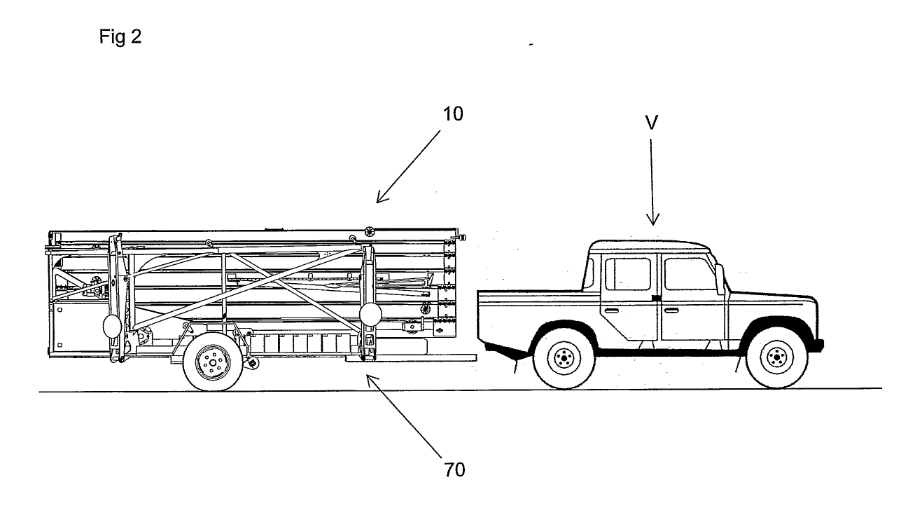

FIG. 2 is a schematic side elevation view of a camera mast assembly according to the invention in a stowed position;

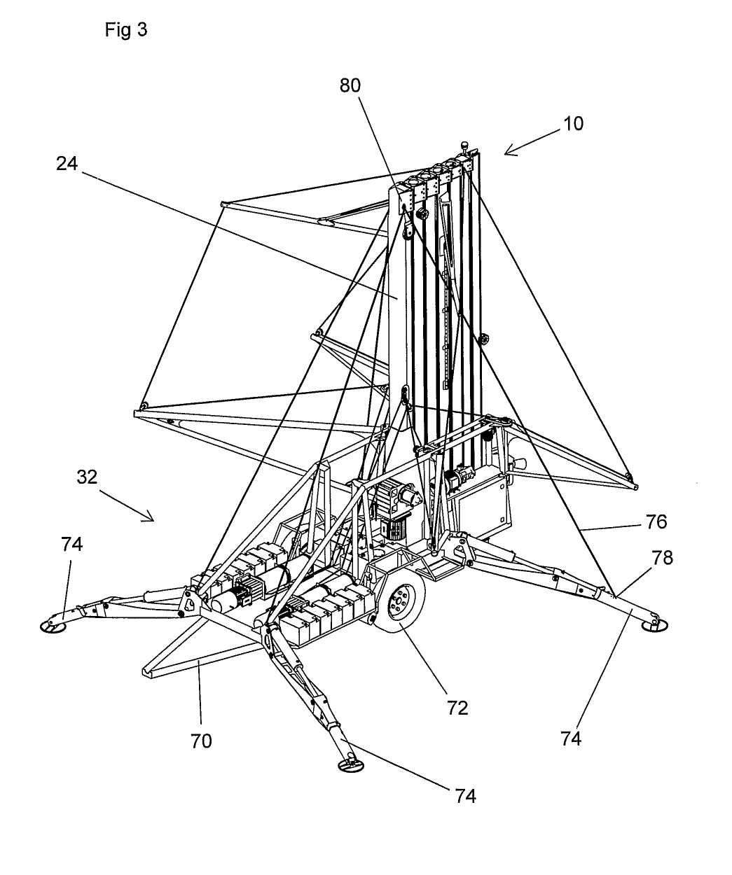

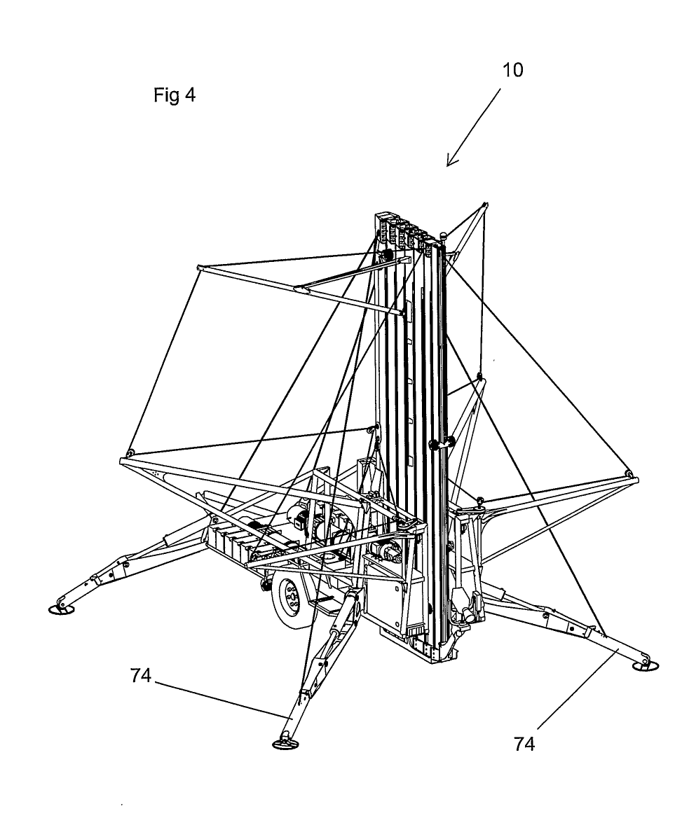

FIGS. 3 and 4 are schematic perspective views of the camera mast assembly in a deployed and lowermost position;

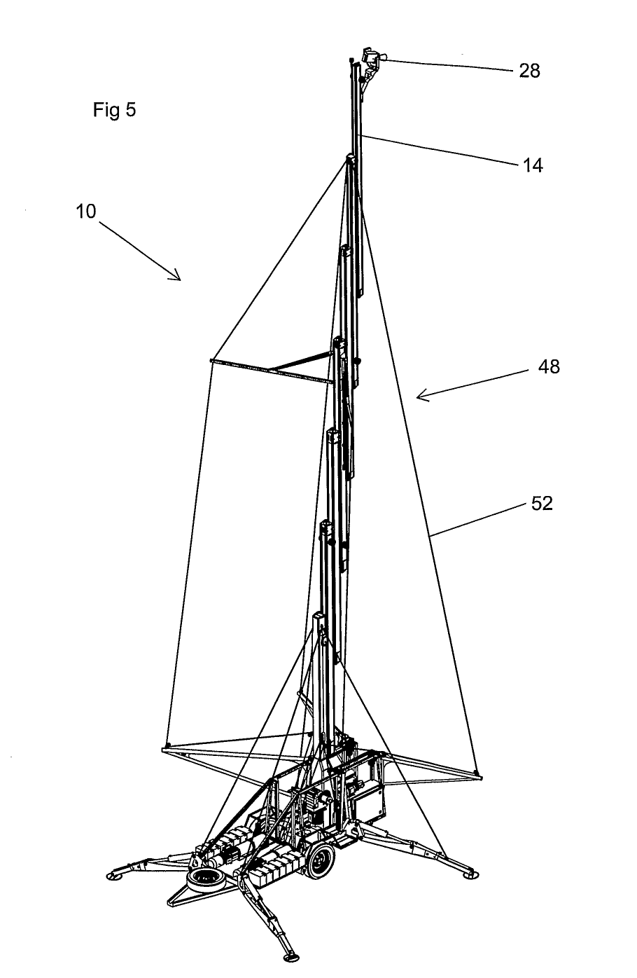

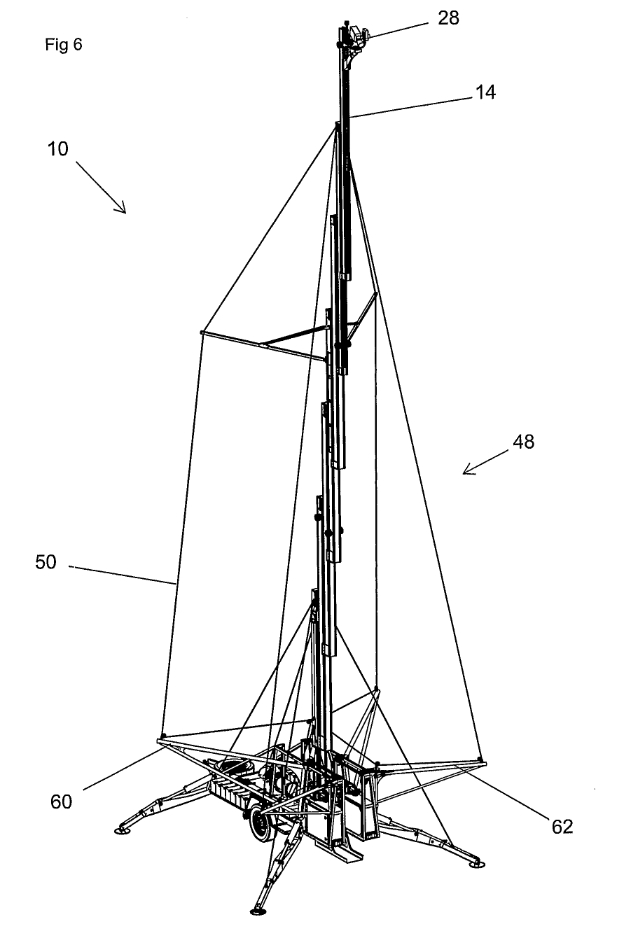

FIGS. 5 and 6 are schematic perspective views of the camera mast assembly in a mast raised 50% configuration;

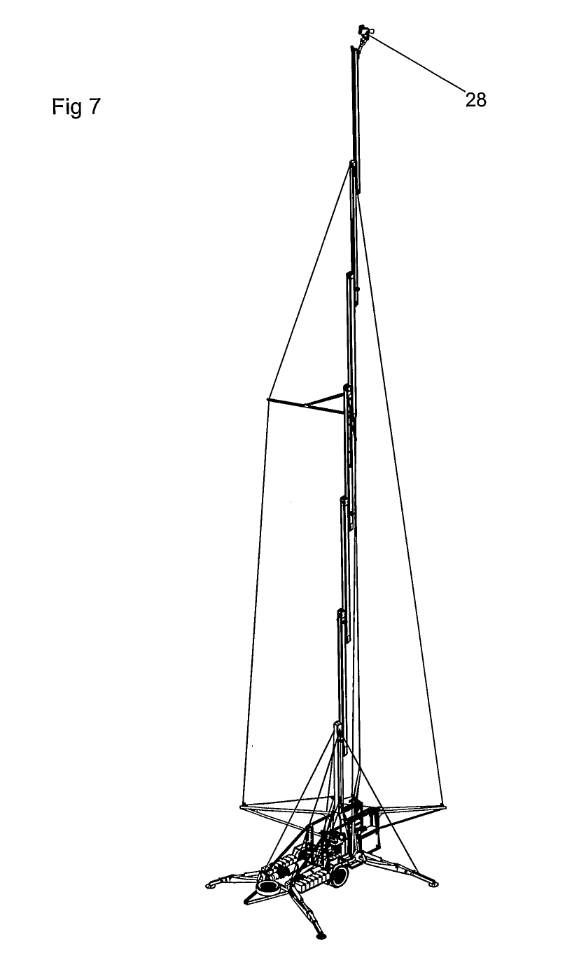

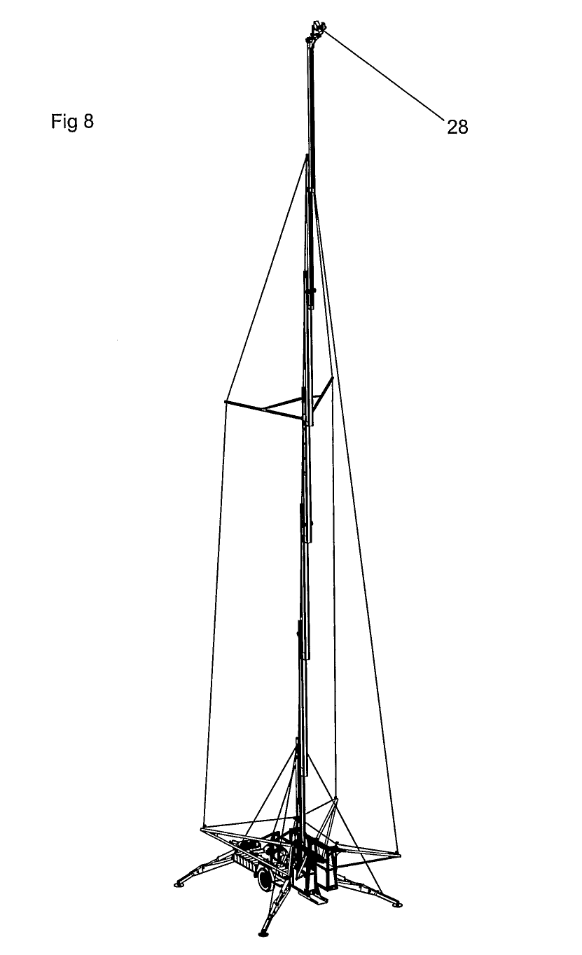

FIGS. 7 and 8 are schematic prospective views of the camera mast assembly with the mast raised 100%;

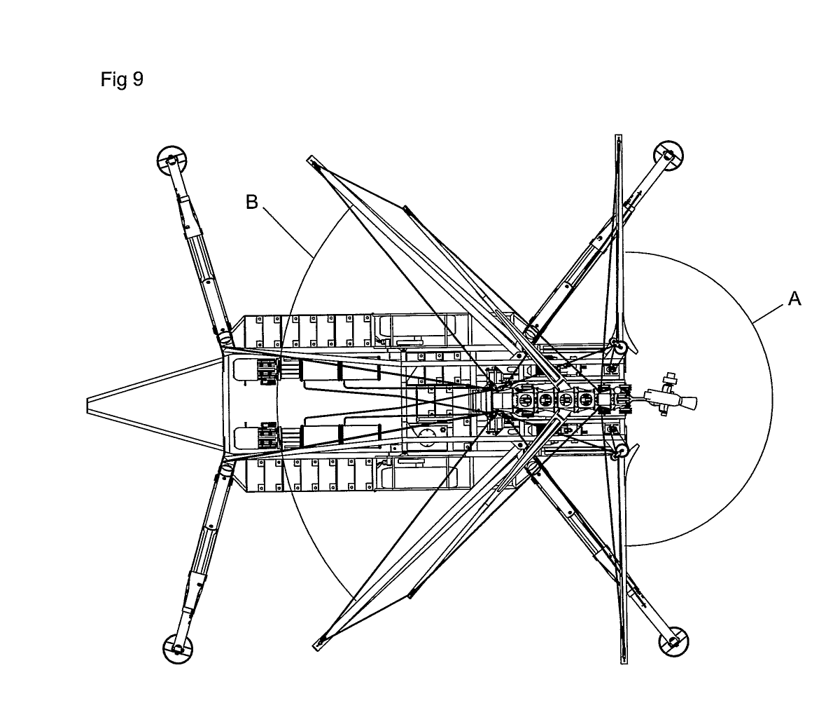

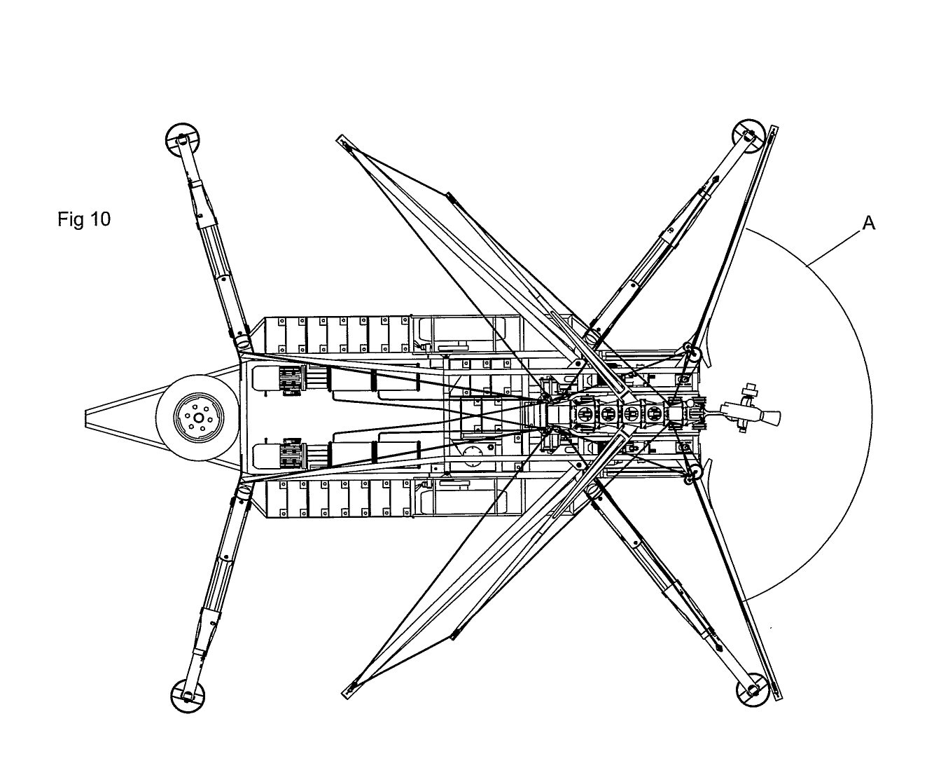

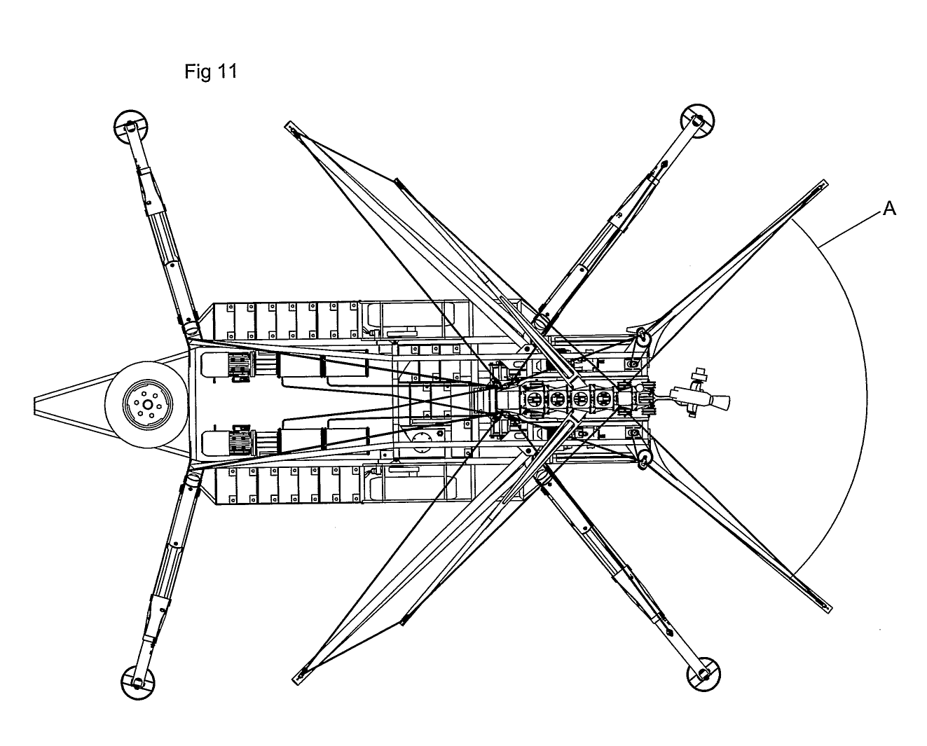

FIGS. 9, 10 and 11 are schematic plan views of the mast in use showing the variation in the configuration of the stabilising mechanism between lower, intermediate and raised positions of the mast;

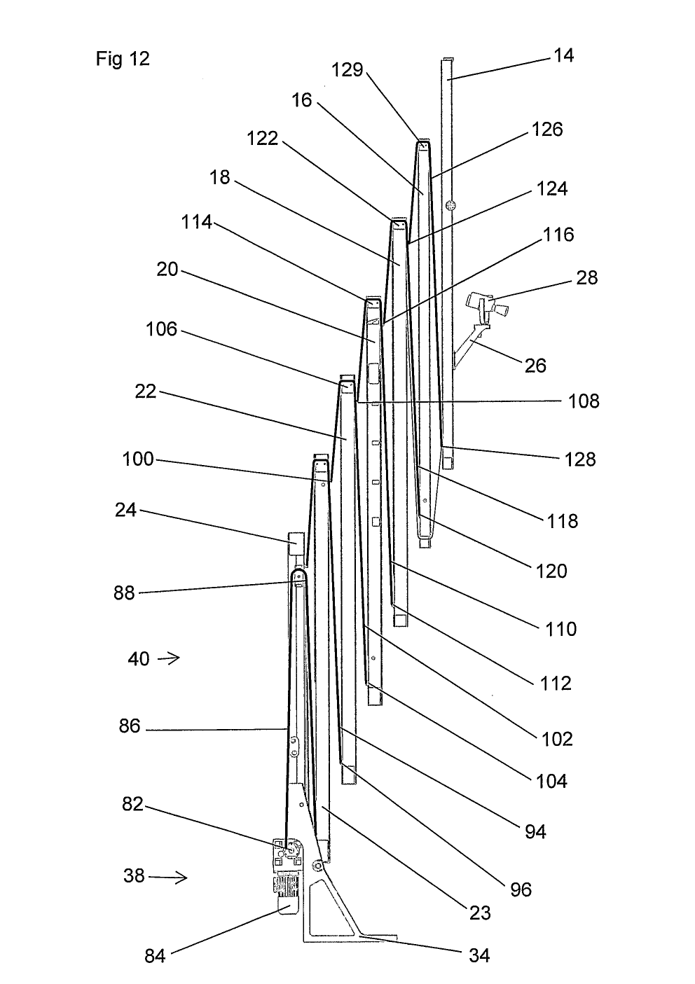

FIG. 12 is a schematic side elevation view of the camera mast assembly in a partially raised configuration highlighting the lifting mechanism;

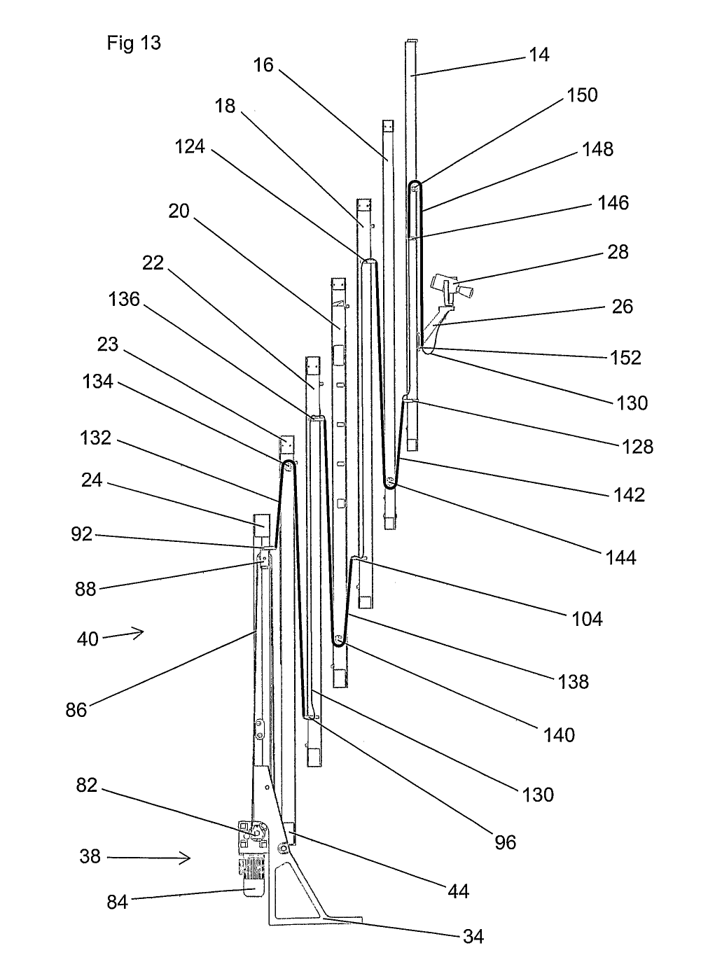

FIG. 13 is a schematic side elevation view substantially similar to that shown in FIG. 12 wherein the camera cabling mechanism is shown;

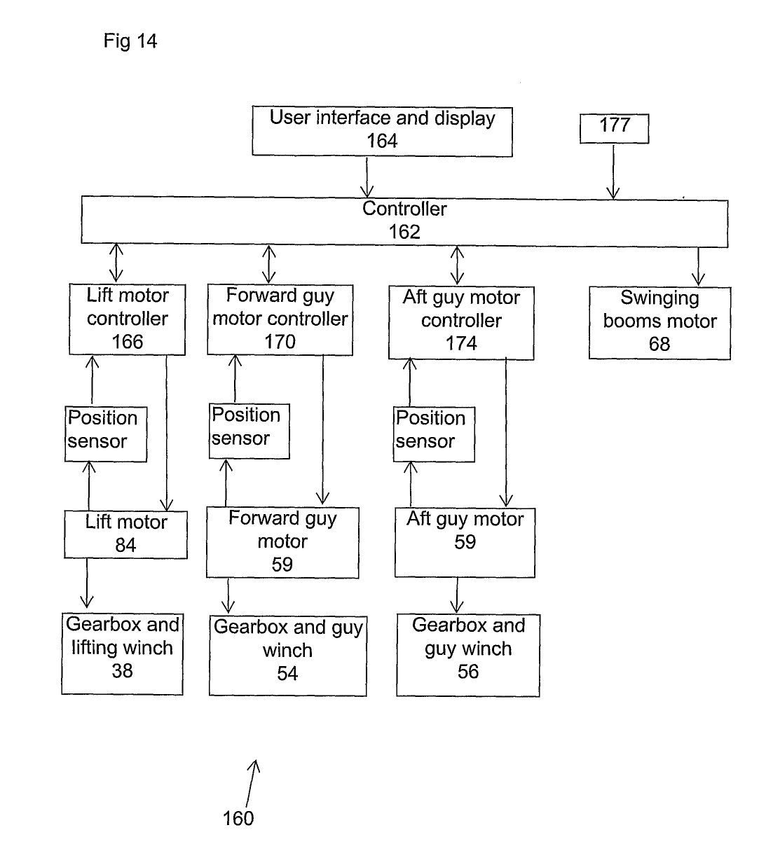

FIG. 14 is a schematic block diagram of an electronic control system for the assembly; and

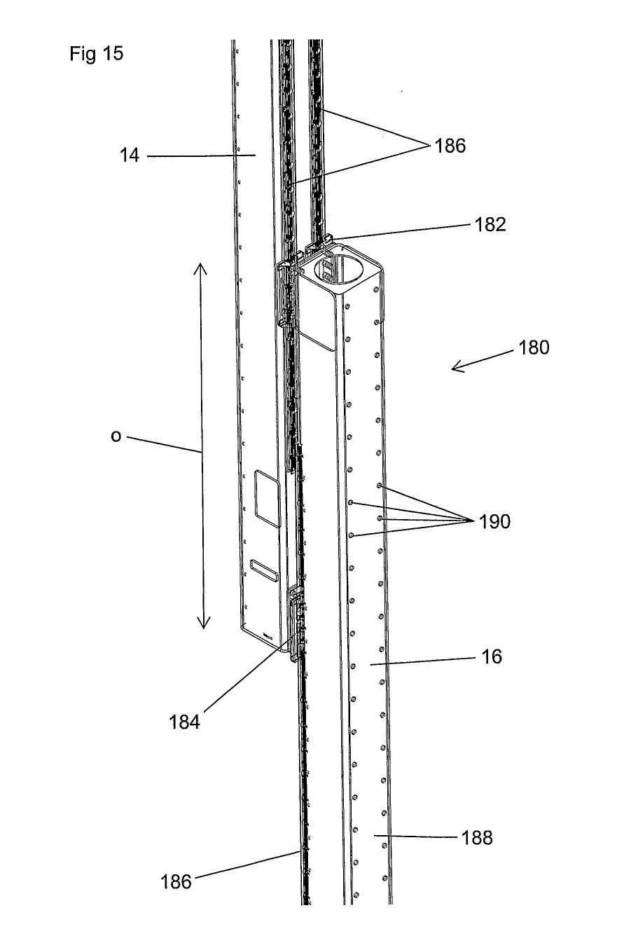

FIGS. 15, 16 and 17 are schematic perspective, side elevation and plan views of the bearings used to enable relative movement of adjacent sections forming part of the mast assembly.

Referring to FIG. 1 there is shown a camera mast assembly 10 according to the invention comprising an array 12 of extendable sections. A first, upper most, section 14 is attached to an adjacent second section 16 which in turn is attached to section 18 and subsequently on through sections 20 and 22 to section 23 which final movable section 23 is attached to a fixed base section 24.

The mast assembly 10 comprises a carriage 26 for a camera 28 and a motor 30 which enables use of a remote control pan and tilt action 30 for varying the field of view of the camera 28 mounted on carriage 26.

The camera mast assembly 10 further comprises a ground engaging feature shown only in part in FIG. 1 as comprising plate 34 attached to the fixed section 24. The plate 34 enables attachment for example to a trailer and/or other ground engaging mechanisms as described later. In particular via a pivot whereby the mast is attached by a pivot to the trailer to let it rotate for transport. There is also a locking pin to hold the mast in the operating position which is also a part of the plate. The mast plate may or may not touch the ground.

The camera mast assembly 10 further comprises a lifting mechanism 36 comprising a main lift winch 38 attached to a series 40 of lifting lines.

The lifting line series 40 comprises several sections the lowermast part of which passes over a pulley 42 at the upper end of fixed section 24 and passes to a fixing point 44 at the lower end of adjacent moveable section 23. A series of lifting line sections is then provided between the fixed mast section 24 and the upper most moveable section, first section 14 which line terminates at an end stop or final fixing on the end most moveable section, first section 14, as described in greater detail later in relation to FIG. 12.

The camera carriage 26 can be attached to the lifting mechanism 36 to enable substantially constant movement of the camera carriage 26 together with the array 12 of extendable sections (14 to 23) through the operation of the lifting mechanism 36, as described later, alternatively a separate camera carriage winch and motor 46 can be provided within the first section 14 independently to control the position of the camera carriage along the length of first section 14.

A stabilising mechanism 48 is also provided comprising a pair of forward guys 50 and a pair of aft guys 52. The stabilising mechanism 48 comprises a forward guy winch drum 54 and an aft guy drum 56. The guys pass over a series of pulleys 58 on fixed mast section 24 and at the ends of booms and spreaders as shown in FIG. 1. In this embodiment, a pair of forward booms 60 are provided which guide the forward guys 50 to a respective pair of spreaders 64, the guys 50 being fixed, in this embodiment, to a top guy fixing 66 at the upper end of the penultimate moveable mast section 16. Similarly, aft guys 52 pass over pulleys attached to aft booms 62 and are also attached to a top fixing 66 at the upper end of movable mast section 14.

A pair of motors 68 are provided to enable movement of the aft booms 62 to adjust the position of the stabilising mechanism 48 in use thereby to maximise the field view of camera 28. The motors 68 are preferably controlled from a central control system 160 described later in relation to FIG. 14.

Similarly a wind sensor 69 is beneficially provided at the top of first mast section 14 which can be linked to the control system 160 for greater feedback in relation to prevailing wind conditions in use, and hence greater control of the stabilising mechanism 48 for example enabling a tensioning of guys if appropriate.

Referring to FIG. 2, the camera mast assembly 10 according to the invention is shown in a stowed position on a trailer 70 adapted to be towed by a vehicle such as an automobile V.

Referring to FIGS. 3 and 4, the camera mast assembly 10 is shown in a first deployed configuration wherein the camera 28 is in its lower most, substantial ground-level position.

In FIGS. 3 and 4, the camera mast assembly 10 can be seen in its deployed configuration wherein trailer 70 acts as a ground engaging mechanism and forms part of the stabilising mechanism 48. The trailer comprises first ground engaging elements in the form of a pair of wheels 72, and a second set of ground engaging elements in the form of extendable legs 74. The legs 74 are positioned approximately in the corners of the rectangular base of the chassis or frame of trailer 70 and enable ground engagement of the trailer 70 in six positions in the form of the invention shown in FIGS. 3 and 4. Beneficially, the legs 74 enable attachment of a series of guys 76 which extend from the fixed mast section 24 at a fixing point 80 towards the upper end of fixed section 24 and an outward position at fitting 78 on legs 74 thereby forming part of the stabilising mechanism 48 of mast assembly 10. In another form the jack legs lift the trailer off the ground so the wheels are clear of the ground.

Referring to FIGS. 5 and 6, the mast assembly 10 is shown in a halfway position wherein the mast is raised 50% of its maximum height. The camera is shown to be located in an uppermost position on the first mast section 14 and accordingly is independently movable in the version shown here. In an alternative form, the camera is locatable at a position halfway along its travel on first section 14, directly in correlation with the relative movement of the array 12 of extendable sections, as described in more detail later.

The stabilising mechanism 48 is also shown in some detail whereby the guys 50 and 52 are deployed in an extended configuration and the booms 60 and 62 extend the lowermost position of the guys horizontally away from the fixed mast section 24 thereby to provide stability to the mast assembly 10.

Referring to FIGS. 7 and 8, the mast assembly 10 is shown in its upper most position whereby the array 12 of extendable mast sections are raised to their uppermost positions and camera 28 is shown at the top of first section 14 thereby providing the maximum angle of elevation for the camera over its field of view.

Referring to FIGS. 9, 10 and 11, plan views of the camera mast assembly 10 according to the invention in the lowermost position (as shown in a perspective view in FIGS. 3 and 4), a mid-position (as shown in a perspective view in FIGS. 5 and 6), and in a fully raised position (as shown in a perspective view in FIGS. 7 and 8) respectively. As can be seen, the angle B between the forward booms 60 is substantially fixed at 90° and in the lowermost position the angle A between the aft booms 62 is substantially 180°. Beneficially, the aft beams 62 are moveable as the mast is raised thereby reducing the angle A to 135° when the mast is raised to its mid point, and to a position whereby A is approximately 90° when the mast is fully raised thereby providing increasing stabilisation of the mast assembly 10 as the mast is raised to its upper most position.

Referring to FIG. 12, a schematic view of the lifting mechanism 36 for raising and lowering the mast assembly 10 is shown. In a preferred form, adjacent mast sections such as section 14 and 16 are held together by a track and bearing arrangement described in further detail in relation to FIGS. 15 to 17. These sections are therefore relatively movable with respect to one another enabling the mast 10 to be extended between its lowermost configuration as shown in FIGS. 3 and 4 for example, to its upper most position as shown in FIGS. 7 and 8. The lifting is effected through use of a main lifting winch 38 comprising a winch drum 82 and motor 84.

A lifting line 40 is used to effect relative motion of adjacent sections in a substantially uniform and smooth manner. The lifting line comprises a first lifting line section 86 attached to winch 82 which line 86 passes over a pulley 88 towards the upper end of static mast section 24 and is attached to a fixing 44 at the lower end of adjacent movable mast section 23, as shown in FIG. 12. A second lifting line section 94 is attached to a fixing point 92 towards the upper end of static mast section 24 and passes over a pulley 98 towards the upper end of movable section 23. Line 94 is attached at a fixing 96 towards the lower end of movable mast section 22. Similarly, a line 102 extends between fixing 100 at the upper end of section 23 and to a lower fixing 104 of section 20 over a pulley 106 towards the upper end of section 22. A further section of lifting line 110 passes between an upper fixing 108 on movable mast section 22 and a lower fixing 112 on movable mast section 18 via a pulley 114 at the upper end of the movable mast section 20. A further lifting line section 118 extends between an upper fixing 116 on movable mast section 20 and a fixing 120 at the lower end of movable mast section 16 via a pulley 20 at the upper end of movable mast section 18.

Finally, in this embodiment a further lifting line section 126 extends between an upper fixing 124 on moveable section 180 and a lower fixing 128 at the lower end of the movable mast section 14 which carries camera 28, via a pulley 129 at the upper end of movable section 16. In a different embodiment, the camera carries 26 can be controlled by a further line section (not shown) which extends between a fixing towards the upper end of mast section 16 and the carriage via a pulley at the upper end of mast section 14. In the embodiment shown, independent camera motor 46 is provided within mast section 14 independently to control the position of the camera carrier 26 and hence camera 28 along the length of mast section 14.

Accordingly, in use the motor 84 is used to deploy or retract the lifting line 40 by winding the first section 86 on and off drum 82. To effect lifting, line 86 is wound onto drum 82 thereby causing movable mast section 23 to slide along the track and bearing arrangement (not shown in FIG. 12) to effect vertical movement of section 23. When mast section 23 is raised, it causes the adjacent section 22 also to raise due to the co-operation of pulley 98 on lifting line section 94. As will be appreciated, each adjacent section moves through the action of a relatively lower mast section to effect substantially smooth, uniform and/or monatonic motion of all of the mast sections and hence the overall mast assembly. This linear relationship is achieved due to the fixed relative positions of the fixings, the fixed length of the lifting line sections, and the simple use of pulleys in order to effect a one to one ratio in the lifting effect of adjacent sections. Other configurations could be achieved through use of different pulley arrangements and/or gearing.

In order to enable the mast to lower, the motor 84 allows drum 82 to unwind lifting line section 86 and hence mast section 23 is able to slide back down static mast section 24 due to gravity. As there can be tension in the guys this will also help the mast retract. Similarly, other sections are able to move relative to adjacent mast sections thereby enabling the mast assembly 10 to gradually collapse into a retracted configuration.

Referring to FIG. 13, there is shown a schematic view of a cabling arrangement 129 between the static mast section 24 and camera 28. Beneficially, the arrangement ensures feed of cable to the camera 28 for carrying control signals to the camera such as focusing and zoom instructions, and for retrieving the photographic imagery. Beneficially, the cabling arrangement 129 ensures that the electrical cabling is not placed under any tension and is constrained within fixed paths of movement during relative motion of the array 12 of masted sections. This is achieved by passing a strong form of cabling such as a sheath for carrying an electrical cable along each of the areas of the mast in which some movement of the electrical cable is required. In this embodiment, the relatively strong cable and/or sheath comprises several sections including a first section 132 which passes between fixing 92 towards the top of static mast section 24 over a pulley 134 towards a second fixing 96 at the bottom end of movable mast 22. The sheath 132 passes over a pulley 134 towards the upper end of movable mast section 23 and carries the electrical cabling 130 within it. Cable 130 runs up the length of movable mast section 22 between fixing 96 and an upper fixing 136 before entering a second relatively strong sheath section 138 which passes between fixing 136 and fixing 104 by a pulley 140. Subsequently cabling 130 passes up the length of mast section 18 between fixings 104 and 124 before entering another section of relatively strong sheathing 142 which passes between fixing 124 at the top of mast section 18 over pulley 144 at the bottom of movable section 16 to a fixing 128 towards the bottom of mast section 14. The cabling 130 then passes up mast section 14 between fixings 128 and 146 before entering a final stage of sheathing 148 which passes between the fixing 146 located approximately centrally on mast section 14 over a pulley 150 to a fixing 152 on camera carriage 26, whereafter the cabling 130 extends to the camera 28 enabling communication therewith. In another form flexible cables can be used outside which don't degrade in UV which cables are sufficiently strong and durable not to require to use of separate sheath.

Accordingly, beneficially the cable 130 is fixed relative to alternate mast sections, (in this example mast sections 24, 22, 18, and part of 14), and where it is movable to allow extension of the array 12 of mast extensions, it is constrained against free movement, by a fixing and pulley arrangements, preferably comprising sheathing to protect the cabling during any movement of the mast 10. The pulleys used for the cabling feed arrangement 129 can be the same and/or co-axial with a pulley used in the lifting mechanism 36 described in relation to FIG. 12. Similarly, the fixings on the mast can also be the same or proximal fixings used in relation to the lifting mechanism.

Referring to FIG. 14, there is shown a schematic block diagram of a control system 160 for effecting lift and stabilisation of the mast assembly 10. The control system 160 comprises a controller 162 such as a central processing unit having a user interface 164 for example comprising a display and user input mechanisms such as an array of buttons and/or keyboard. The controller 162 communicates with a lift motor controller 166 which drives lift motor 84 and hence the gearbox and lifting winch 38. Preferably a position sensor 168 such as an optical encoder on the lift motor 84, and/or further sensors on the array 12 of mast sections, is provided in order to enable feedback to the lift motor controller 166 regarding the position of the winch motor, with gearbox, lifting winch drum, and/or mast sections. Controller 162 is also in communication with a forward guy motor controller 170 which controls the forward guy motor 59 and hence gear box and lifting winch 54. Again, position sensor or sensors 172 are provided such as optical encoders on the forward guy motor 59 and/or position sensors for detecting the position of forward guys 59. Hence feedback is enabled to the forward guy motor controller 170 to enable accurate control of the forward guy motor 59 and hence accurate stabilisation of the mast assembly 10. Controller 162 is further in communication with an aft guy motor controller 174 which controls the aft guy motor 59 and hence gearbox and lifting winch 56. Again, position sensors 176 such as optical encoder on aft guy motor 59 can be provided and/or further position sensors can be provided to monitor the position of aft swing booms 62 and/or aft guys 52 to enable greater sensitivity in the stabilisation control of the mast assembly 10. The controller 162 can also take external data via a communication port 177 for example for receiving wind information from wind sensor 69 located at the top of the mast as shown in FIG. 1.

In one form the lifting mechanism winches the guys keeping them in tension at all times, therefore the mast stabilisers move. The winch motors are digitally locked at the controller 162, and guy tension is monitored at the motor controller (166, 170) by sensing the current drawn by the motor, which means that the tension can be varied, eg reduced to save power or increased in stronger winds.

The controller 162 further controls the position of the swing boom motors 68 (see FIG. 1) to control the position of the aft swing booms as described in relation to FIGS. 9, 10 and 11.

Beneficially, controller 162 is programmable to enable adjustment of the lifting mechanism in response to instructions by a camera operator, and beneficially automatically to adjust the stabilisation control of the mast based on feedback data regarding the position of the mast, movement of the mast due to wind, and/or speed of wind from a wind sensor 69, for example, in order, to optimise the extent of use of a camera 28 in varying weather conditions.

The track and bearing arrangement for enabling relative movement of the movable mast sections, is shown in further detail in relation to FIGS. 15, 16 and 17. In FIG. 15 the example shown is of mast section 14 and mast section 16 which can comprise a tube having a substantially square cross-section. Abutting faces of the sections 14 and 16 need to carry a set of bearings for engaging tracks which run along the length of the tubes. A top set of bearings 182 is located towards the upper end of section 16 and a lower set of bearings 184 is fixed to the lower end of section 14. A pair of parallel tracks 186 is provided below a top set of bearings 182 on section 16 and above a lower set of bearings 184 on section 14. The top set of bearings 182 comprises a pair of bearings for engaging each of the parallel tracks 186 on section 14 and similarly a lower set of bearings 184 comprises a pair of bearings for engaging each of the parallel tracks 186 on relatively lower mast section 16. The tracks 186 and bearings 182 and 184 are mountable on the mast section 14 and 16 using fixing such as nuts and bolts to attach the tracks and bearings to the face of the mast section. Preferably, the faces such as 188 of mast section 16 comprise an array apertures 190 to enable using the attachment of tracks and bearings thereon.

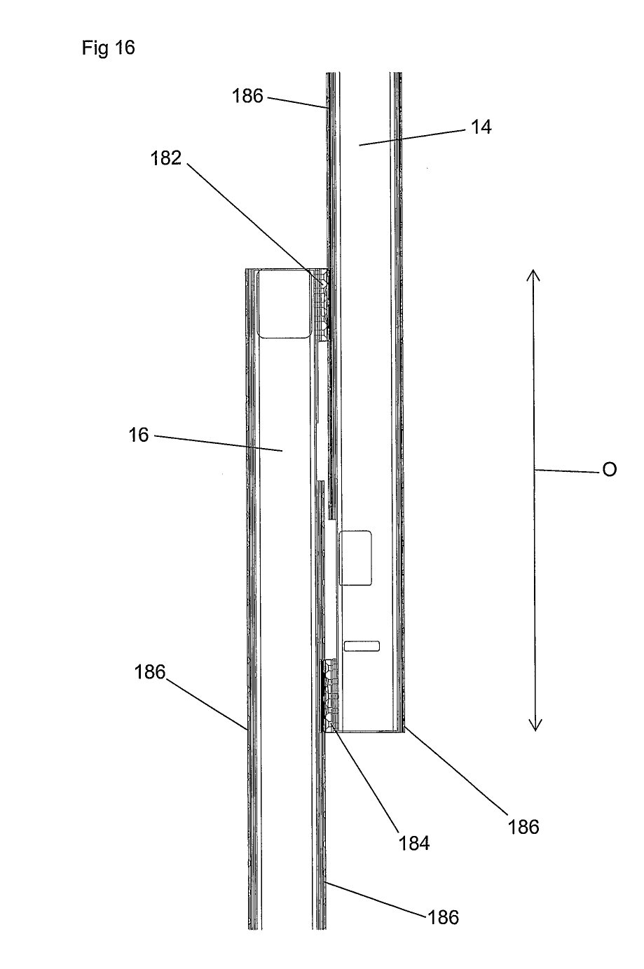

Referring to FIG. 16 it can be seen that the fixed overlap of the adjacent sections can be determined by the length of the track 186 at the interface between the sections, and/or a stop provided at the end of the sections and/or abutting the tracks against the bearing so that the bearings act as a their own stop thereby to minimise the redundant overlap O between sections provided the bearings 182 and 184 are provided at the lower most and upper most positions on the respective section. However, it is found desirable in order to provide greatest stability for the mast assembly 10 in order to provide a residual overlap O which preferably is in the order of ⅕ the length of each mast section.

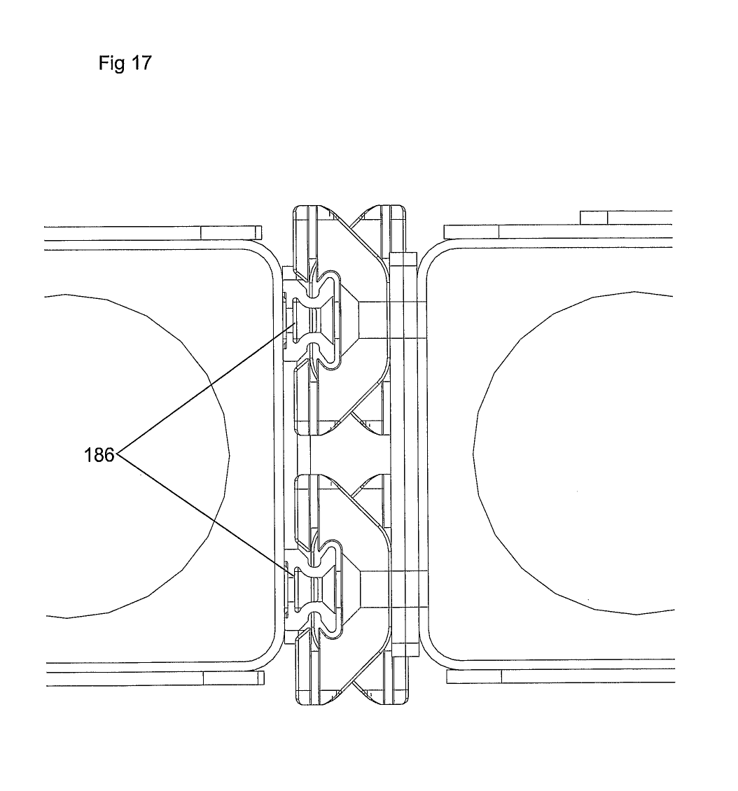

Referring to FIG. 17, further detail of the shape of the tracks and bearings are shown. Preferably the bearings can comprise captive circulating ball runs to enable low friction motion with respect to the tracks. Other low friction bearings can be provided. In there preferred form, the bearings comprise a bracket having a substantially C shape cross section wherein the ends of the bracket are engaged in a recess in the track, which has a substantially X shape cross-section, thereby to provide mechanical location of the bearing and track again to provide stability to the mast assembly 10.

1. A camera mast assembly comprising two or more sections movable with respect to one another from an unextended to an extended configuration, and a carriage attached to one of the sections for mounting a camera on the assembly, wherein the carriage is continuously movable in a substantially uniform manner from a first position wherein the sections are in the unextended configuration to a second position wherein the sections are in the extended configuration.

2. A camera mast assembly according to claim 1 wherein the carriage is attached in a fixed position relative to the one of the sections.

3. A camera mast assembly according to claim 1 wherein the carriage is moveably attached to the one of the sections.

4. A camera mast assembly according to claim 3 wherein the carriage is moveable in a substantially uniform manner relative to the one of the sections to which it is attached in correlation with the substantially uniform movement of the two or more sections as they move between the unextended and extended configurations.

5. A camera mast assembly according to claim 4 wherein the movement of the carriage relative to the one of the sections is directly linked with the relative movement of the two or more sections as they move between the unextended and extended configurations.

6. A camera mast assembly according to claim 1, wherein the carriage is positionable near a bottom of and movable along the one section to which it is attached, and preferably wherein the carriage is positionable close to ground level in a lowermost position of the mast in use.

7. A camera mast assembly according to claim 1, wherein the relative motion of the two or more sections between the unextended and extended configuration is substantially linear and preferably vertical motion in use.

8. A camera mast assembly according to claim 1, comprising three or more sections.

9. A camera mast assembly according to claim 1, wherein the relative movement of adjacent sections in moving from the unextended to extended configuration is greater than two metres and preferably in the order of three metres.

10. A camera mast assembly according to claim 1, comprising between five and ten sections inclusive, which are relatively moveable.

11. A camera mast assembly according to claim 1, comprising a lifting mechanism for effecting relative movement of the two or more sections with respect to one another.

12. A camera mast assembly according to claim 11 wherein in use the lifting mechanism is adapted to effect movement of a first section being mechanically linked to an adjacent relatively moveable second section such that movement of the first section causes correlated movement of the second section.

13. A camera mast assembly according to claim 12 wherein the first and second section are linked so as to effect substantially equal and directly related movement of the second section with respect to the first section upon movement of the first section.

14. A camera mast assembly according to claim 13 wherein the first and second section are linked by a substantially non-extendable elongated member such as a cable or rope.

15. A camera mast assembly according to claim 14 comprising three or more relatively moveable sections each section being linked to adjacent relatively moveable sections by a substantially non-extendable member such as cable.

16. A camera mast assembly according to claim 1, wherein adjacent relatively moveable sections are joined together by a bearing enabling relatively low friction motion of the sections relative to one another.

17. A camera mast assembly according to claim 16 wherein each adjacent section comprises a fixed bearing element attached thereto and being relatively moveable with respect to the adjacent section so as the interface between two adjacent sections comprises at least two bearings.

18. A camera mast assembly according to claim 1, wherein a relatively upper most section comprises a relatively lower most bearing element and a relatively lower most section comprises a relatively upper most bearing element in an interface between the two adjacent sections such that in most extended form of the adjacent sections relative to one another, the lower most bearing element on the upper most section, abuts or is proximal the upper most bearing provided by the lower most section.

19. A camera mast assembly according to claim 18 wherein a separation of the bearing elements when the two adjacent sections are in a most extended form defines an overlap dimension which dimension is preferably in an order of one fifth of an overall length of one of the sections.

20. A camera mast assembly according to claim 1, wherein the sections are moveable at a rate greater than 1 metre per second and preferably in the order of 2 metres per second.

21. A camera mast assembly according to claim 1, comprising a stabilising mechanism adapted to provide camera stability in use to enable operation of the camera in at least moderate winds.

22. A camera mast assembly according to claim 21 wherein the stabilising mechanism comprises adjustable guys enabling adjustment of the stabilising mechanism according to a position of the mast.

23. A camera mast assembly according to claim 22 wherein a position of one or more of the stabilising features of the stabilising mechanism is moveable between a more optimal and less optimal mast stabilising configuration as the mast is lowered thereby to enable a greater field of view of the camera in use.

24. A camera mast assembly according to claim 1, wherein a moveable boom is provided to adjust a position of a guy, and preferably wherein the boom is moveable to rotate the position of the guy out of a field view of the camera.

25. A camera mast assembly according to claim 1, comprising a control mechanism for controlling one or more of the lifting mechanism and stabilising mechanism, and preferably both in the correlated matter to optimise a range of movement and field of view of a camera in use.

26. A camera mast assembly comprising one or more position sensors for monitoring a position of one or more of a lifting mechanism and a stabilising mechanism.

27. A camera mast assembly according to claim 1, comprising one or more motors for effecting lifting of the mast and/or positioning of the stabilising guys, and the one or more motors are preferably operably mounted on a trailer for moving and positioning the camera mast assembly.

28. A camera mast assembly according to claim 1, being adapted to collapse into a stowed position and preferably mountable on a trailer for towing by a vehicle such as an automobile, and preferably wherein the mast is moveable from a substantially vertical operable position to a substantially horizontal stowed position.

29. A camera mast assembly according to claim 28 wherein the trailer forms part of the assembly and preferably comprises extendable legs to engage the ground thereby to provide a stable platform for the mast in use.

30. A camera mast assembly comprising two or more sections movable with respect to one another from an unextended to an extended configuration, and a carriage attached to one of the sections for mounting a camera on the camera mast assembly wherein the carriage is movable along a length of the one of the sections to which it is attached, preferably enabling positioning of the carriage below a top of the other of the relatively movable sections when the sections are in an unextended configuration.

31. A camera mast assembly according to claim 30 wherein the carriage is movable between a lowermost position proximal a lower end of the sections to which it is attached, preferably being a substantially lowermost position and/or ground level position of the mast assembly, and an uppermost position at an upper end of the section to which it is attached which in an extended form of the mast assembly, is a substantially uppermost position of the mast.

32. A camera mast assembly according to claim 1, wherein the carriage is movable along a length of the one of the sections to which it is attached, preferably enabling positioning of the carriage below a top of the other of the relatively movable sections when the sections are in an unextended configuration.

33. A camera mast assembly comprising two or more sections movable with respect to one another from an unextended to an extended configuration and a carriage attached to one of the sections for attaching a camera on the assembly, further comprising a cabling arrangement for feeding electrical cable to a camera mounted on the carriage in use, the cabling arrangement being adapted to constrain movement of the cabling during movement of the sections when raising and lowering the mast assembly.

34. A camera mast assembly according to claim 33 wherein sections of the cabling arrangement fixed the cabling along substantial lengths of one or more of the two or more sections.

35. A camera mast assembly according to claim 33 wherein the cabling arrangement comprises cable sheathing to prevent tensioning of electrical cabling in use during movement of the two or more sections.

36. A camera mast assembly according to claim 1, further comprising a cabling arrangement for feeding electrical cable to a camera mounted on the carriage in use, the cabling arrangement being adapted to constrain movement of the cabling during movement of the sections when raising and lowering the mast assembly.

37. A camera mast assembly comprising two or more movable mast sections, a lifting mechanism for moving the mast sections, a stabilising mechanism for stabilising the mast, and a controller adapted to enable adjustment of the lifting mechanism in response to instructions from a user and automatically to adjust the stabilising mechanism in response to input data derived from one or more movable sections of a position of the mast, movement of the mast due to wind and/or wind speed, thereby to optimise an extent of use of a camera in varying weather conditions.

38. A camera mast assembly according to claim 1, further comprising a lifting mechanism for moving the mast sections, a stabilising mechanism for stabilising the mast, and a controller adapted to enable adjustment of the lifting mechanism in response to instructions from a user and automatically to adjust the stabilising mechanism in response to input data derived from one or more movable sections of a position of the mast, movement of the mast due to wind and/or wind speed, thereby to optimise an extent of use of a camera in varying weather conditions.

39. An adjustable mast for raising and lowering an object such as a camera, aerial, antenna or the like, comprising two or more sections movable with respect to one another from an unextended to an extended configuration, and a carriage attached to one of the sections for mounting an object on the assembly, wherein the carriage is continuously movable in a substantially uniform manner from a first position wherein the sections are in the unextended configuration to a second position wherein the sections are in the extended configuration.

40. A camera mast assembly comprising a camera adjustment mechanism enabling at least one degree, and preferably two or three degrees, of movement of a camera and preferably one or more of raising and lowering the camera (or camera carriage), rotating the camera about a substantially vertical axis and tilting the camera about a substantially horizontal axis.

41. A camera mast assembly according to claim 40 wherein the lifting of the camera carriage is independent of the movement of the mast.

42. A camera mast assembly according to claim 1, further comprising:
a lifting mechanism for moving the mast sections, a stabilising mechanism for stabilising the mast, and a controller adapted to enable adjustment of the lifting mechanism in response to instructions from a user and automatically to adjust the stabilising mechanism in response to input data derived from one or more movable sections of a position of the mast, movement of the mast due to wind and/or wind speed, thereby to optimise an extent of use of a camera in varying weather conditions; and
a carriage attached to one of the sections for mounting an object on the assembly, wherein the carriage is continuously movable in a substantially uniform manner from a first position wherein the sections are in the unextended configuration to a second position wherein the sections are in the extended configuration.
